(19) United States
(12) Patent Application Publication
(10) Pub. No.: US 2011/0137743 A1
(43) Pub. Date: Jun. 9, 2011

(54) SYSTEMS AND METHODS OF PRODUCT PLACEMENT

(75) Inventors: Michael John Campion, San Clemente, CA (US); James Alexander Langteaux, Laguna Beach, CA (US); Christopher John Falson, Studio City, CA (US); Franklin John Thompson, III, Lake Forest, CA (US)

(73) Assignee: PEAPOD MUSIC, LLC, San Clemente, CA (US)

(21) Appl. No.: 13/029,012

(22) Filed: Feb. 16, 2011

Related U.S. Application Data
(63) Continuation of application No. 11/378,006, filed on Mar. 17, 2006.
(60) Provisional application No. 60/663,104, filed on Mar. 18, 2005.

(51) Int. Cl. G06Q 30/00

(52) U.S. Cl. 705/26.1

(57) ABSTRACT

A product seller site distributes on a pay for placement basis placed product with purchased product when the purchased product is delivered, where the placed product is associated with the purchased product by at least one specific characteristic. For example, the owner of a product funds an account and supplies product samples to be distributed to customers purchasing similar products. Further, the product owners bid or pay a fee to place their product with the customer. When the customer purchases a product, a search engine determines which products from a database of products available for placement meet the search criteria and offers to distribute the placement product with the purchased product. The search criteria comprise matching the purchased product with similar products to be placed with the purchased product and finding the highest bidder or fee from the group of matching placement products. The account associated with the matching placement product is debited when the matching placement product is distributed to the customer.

The present application claims priority to U.S. patent application Ser. No. 11/378,006, filed Mar. 17, 2006, titled “SYSTEMS AND METHODS OF PRODUCT PLACEMENT”, which claims priority benefit under 35 U.S.C. §119(e) from U.S. Provisional Application No. 60/663,104, filed Mar. 18, 2005, titled “SYSTEMS AND METHODS OF PRODUCT PLACEMENT”, the entireties of both of which are hereby incorporated herein by reference.

### BACKGROUND OF THE INVENTION

1. Field of the Invention

This invention relates generally to product distribution, and more particularly to paying a fee to place a first product with a second product when the second product is presented.

2. Description of the Related Art

It can be very difficult for manufacturers or distributors to distribute their products to consumers. Major retailers typically display and offer for sale well-known products and largely ignore products from unknown or small manufacturers or distributors. This limits the consumers' choices.

Using the music industry as an example, it can be difficult for new music artists to distribute their music to consumers. Major music retailers typically display and offer for sale music from well-known, mainstream artists and largely ignore unknown artists. This limits the music consumers' choices to less than 10% of the music that is currently available.

### SUMMARY OF THE INVENTION

In an embodiment, new music artists provide music to deliver to customers when the customers purchase similar music from music resellers. In an embodiment, the music reseller is an on-line store that sells downloadable digital content, such as songs formatted as MP3 files, videos formatted as MPEG files, downloadable text, such as articles and books, ring tones, and the like. In another embodiment, the music reseller sells products, such as compact discs audio (CDs), digital video discs (DVDs), and the like.

The music artist provides song information and song associations, which indicate songs, artists, or albums that are similar to artist's music. The artist's song information and song associations are stored in a song profile database. Further, the music artist funds an account and bids to have his music delivered to customers who purchase similar music. In an embodiment, the artists, typically mainstream artists, are compensated when their songs or albums are used in an association.

In an embodiment, a customer selects music from a music reseller and is offered music that is similar in style to the selected music. In an embodiment, the offered music is complementary to the customer. When the customer accepts the offer, the song information associated with the selected music is cross-referenced with the music information stored in the song profile database to determine which music in the database shares similar characteristics with the music the customer selected.

In an embodiment, the song profile database comprises a first database, which has song information provided by individual, independent music artists, and a second database, which has song information provided by non-independent music artists, such as recording companies, and the like.

In another embodiment, unique customer identification is also sent to the database. The unique customer identification is used to identify songs previously placed with the customer so that the same customer does not receive the same placed song more than once. The unique customer identification is cross-referenced with information stored in an artist historical database to remove songs previously sent to the customer from the group of songs that are similar to the music the customer selected.

To increase the likelihood of placing their song with a similar song selected by the customer, music artists can bid against one another for placement with the customer. An independent artist-bidding engine determines which music artist associated with a song that is similar to the selected music has the highest bid. The artist-bidding engine further determines whether the artist with the highest bid has sufficient funds in his account. The music artist with the highest bid and sufficient funds pays to have his music delivered to the customer. In an embodiment, the song associated with the winning bid is delivered to the customer. In an embodiment, the song associated with the winning bid is delivered to the customer along with the customer's selected music. When the music artist's song is delivered to the customer, the artist's account is debited by the amount of the bid.

The artists can promote their music to customers who are pre-screened or pre-qualified to enjoy music that is similar to the artists' style of music. Customers who enjoyed the complimentary song can purchase additional music by the artist from the placement service or the music reseller.

While an embodiment of the invention is described with respect to distributing music, any downloadable digital content, or any physical product could be advertised and distributed in this manner.

In another embodiment, the owner of a secondary product bids for product placement, funds an account, and supplies secondary product samples to be distributed to customers purchasing similar primary products. When the customer purchases a primary product, a search engine determines which products from a database of secondary products available for placement meet the search criteria and offers to distribute the secondary product to the customer with or without the primary product. In an embodiment, there is no charge to the customer for the secondary product. The search criteria comprise matching the primary product with similar secondary products.

In another embodiment, the product owner can bid to increase the likelihood of placing the secondary product with the primary product. The matching secondary product having the highest bid is distributed to the customer and the account associated with the secondary product is debited.

In an embodiment, a method of data object distribution comprises receiving at least one unique identifier associated with a primary data object and at least one unique identifier associated with a secondary data object, associating the secondary data object with the primary data object, and debiting an account associated with the secondary data object when the secondary data object is presented.

In another embodiment, a method of data object distribution comprises receiving at least one characteristic associated with a primary data object, receiving at least one unique identifier, at least one characteristic, and a fee amount associated with a secondary data object, determining whether the characteristic associated with the secondary data object matches the characteristic associated with the primary data object, and debiting an account associated with the secondary data object by the fee amount when the secondary data object and the primary data object have at least one matching characteristic and when the secondary product is presented.

In a further embodiment, a method of music distribution comprises receiving at least one song identifier, and a fee associated with a song, identifying music selected by a customer, and debiting an account associated with the song when the song is presented.

In yet another embodiment, a method of music distribution comprises receiving at least one song identifier, at least one characteristic, and a fee associated with a song, determining whether the characteristic associated with the song matches at least one characteristic associated with purchased music, and debiting an account associated with the song by the charge when the song and the purchased music have at least one matching characteristic and when the song is delivered.

In an embodiment, a method of music distribution comprises receiving at least one song identifier, at least one characteristic, and a fee associated with a song, determining whether the characteristic associated with the song matches at least one characteristic associated with purchased music, and debiting an account associated with the song by an amount of the fee when the song and the purchased music have at least one matching characteristic and when the song is presented.

In another embodiment, an apparatus for music distribution comprises a storage device configured to store at least one song identifier, at least one characteristic, and a fee associated with a song, a processor configured to determine whether the characteristic associated with the song matches at least one characteristic associated with purchased music, and an account associated with the song, wherein the account is debited by an amount of the bid when the song and the purchased music have at least one matching characteristic and when the song is presented.

In a further embodiment, an apparatus for music distribution comprises means for receiving at least one song identifier, at least one characteristic, and a fee associated with a song, means for determining whether the characteristic associated with the song matches at least one characteristic associated with purchased music; and means for debiting an account associated with the song by an amount of the fee when the song and the purchased music have at least one matching characteristic and when the song is presented.

In yet another embodiment, a method of music distribution comprises receiving at least one identifier associated with a song selected by a consumer, determining whether the song selected by the consumer is associated with at least a second song, issuing a message approving download of the associated second song to the consumer, and debiting an account associated with a promoter of the second song by an amount when the second song is presented to the consumer.

In an embodiment, a method of product distribution comprises receiving at least one product identifier associated with a primary product and at least one product identifier associated with a secondary product, presenting the secondary product with the primary product, and debiting an account associated with the secondary product when the secondary product is presented.

In an embodiment, a method of product distribution comprises receiving at least one characteristic associated with a primary product, receiving at least one product identifier, at least one characteristic, and a bid amount associated with a secondary product, determining whether the characteristic associated with the secondary product matches the characteristic associated with the primary product, and debiting an account associated with the secondary product by the bid amount when the secondary product and the primary product have at least one matching characteristic and when the secondary product is delivered. The method further comprises receiving at least one product identifier, at least one characteristic, and a bid associated with each of a plurality of secondary products, determining whether the characteristic associated with each of secondary products matches the characteristic associated with the primary product to produce a group of matching secondary products, determining which matching secondary product from the group of matching secondary products is associated with the highest bid, and debiting an account associated with the highest bid secondary product when the highest bid secondary product is delivered.

In another embodiment, a method of music distribution comprises receiving at least one song identifier, and a bid associated with a song, identifying selected music, and debiting an account associated with the song when the song is delivered.

In a further embodiment, a method of music distribution comprises receiving at least one song identifier, at least one characteristic, and a charge associated with a song, determining whether the characteristic associated with the song matches at least one characteristic associated with purchased music, and debiting an account associated with the song by the charge when the song and the purchased music have at least one matching characteristic and when the song is delivered.

In another embodiment, a method of music distribution comprises receiving at least one song identifier, at least one characteristic associated with the song, and a bid associated with the song, determining whether the characteristic associated with the song matches at least one characteristic associated with purchased music, and debiting an account associated with the song by an amount of the bid when the song and the purchased music have at least one matching characteristic and when the song is delivered.

In another embodiment, an apparatus for music distribution comprises a storage device configured to store at least one song identifier, at least one characteristic, and a bid associated with a song, a processor configured to determine whether the characteristic associated with the song matches at least one characteristic associated with purchased music, and an account associated with the song, wherein the account is debited by an amount of the bid when the song and the purchased music have at least one matching characteristic and when the song is delivered.

In a further embodiment, an apparatus for music distribution comprises a means for receiving at least one song identifier, at least one characteristic, and a bid associated with a song, a means for determining whether the characteristic associated with the song matches at least one characteristic associated with purchased music, and a means for debiting an account associated with the song by an amount of the bid when the song and the purchased music have at least one matching characteristic and when the song is delivered.

In yet another embodiment, a method of music distribution comprises receiving at least one identifier associated with a song selected by a consumer, determining whether the song selected by the consumer is associated with at least a second song, downloading the second song to the consumer when the song selected by the consumer is associated with the second song, and debiting an account associated with a promoter of the second song by an amount when the second song is delivered to the consumer.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 illustrates an embodiment of a music placement process.

FIGS. 2, 2A, 2B are flow charts showing a music placement process, according to another embodiment of the invention.

FIG. 3 illustrates an embodiment of a music placement system.

FIGS. 4, 4A, 4B are flow charts showing an artist enrollment process, according to an embodiment of the invention.

FIGS. 5, 5A, 5B are flow charts showing a song enrollment process, according to an embodiment of the invention.

FIG. 6 is a flow chart showing a bidding-for-placement process, according to an embodiment of the invention.

FIG. 7 is a flow chart showing a music placement process, according to an embodiment of the invention.

FIG. 8 is flow chart showing song selection, according to an embodiment of the invention.

FIG. 9 is an exemplary screen shot illustrating an Artist Administration page.

FIG. 10 is an exemplary screen shot illustrating a Song Association Administration page.

### DETAILED DESCRIPTION OF THE PREFERRED EMBODIMENTS

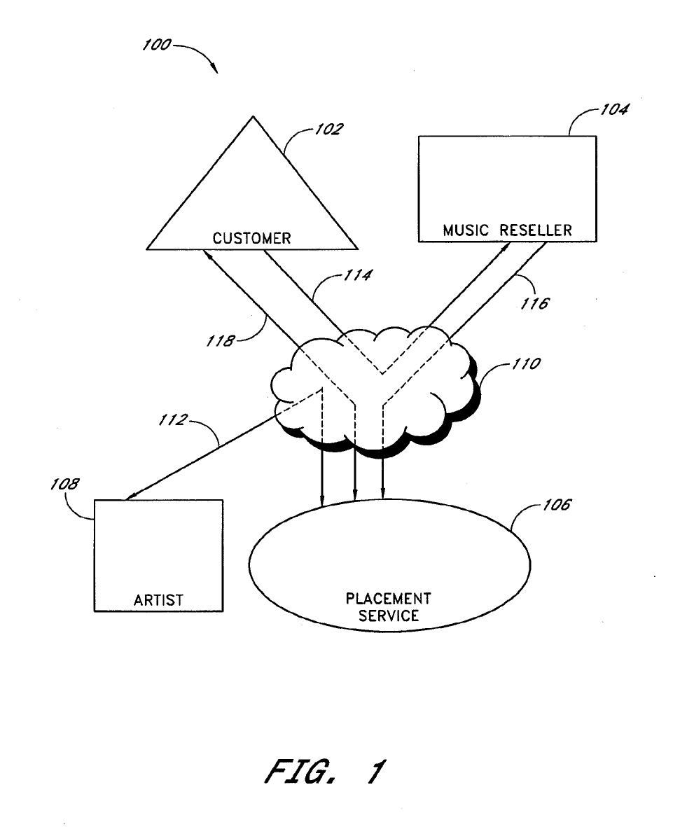

FIG. 1 illustrates an embodiment of a music placement process 100. An artist 108 interfaces with a placement service 106 through a communication medium 110, which is indicated by path 112, for placement of the artist's items with a customer 102. The artist 108 can be any individual or organization that owns the rights to an item, where an item can be delivered as digital content or a physical product. In an embodiment, the artist 108 comprises an independent music artist 108 and the item comprises a song. In another embodiment, the artist 108 is an organization that can represent one or more music artists, such as a record label company, or the like.

The artist 108 provides the item, such as a song or a song identifier, song associations, and a bid amount. In an embodiment, the song associations comprise song titles, album titles, or other musical artists. Typically, the artist 108 chooses associations from mainstream musicians that the customer 102 recognizes. The artist 108 chooses associations that are similar in style, genre, mood, theme, instrumentation, musical influences, or the like to the artist's item. The bid is the amount the artist 108 is willing to pay the placement service 106 each time the placement service 106 places the artist's song with the customer 102.

By placing artist's songs with customers 102 who have purchased or selected similar music, the placement service 106 offers artists 108 an opportunity to introduce their music to customers 102 or music-buyers who are pre-qualified to enjoy the artist's music and/or the artist's style of music. To increase the chances of the artist's items placing with specific associated items requested by the customer 102, the artists 108 can adjust the bid amount. In an embodiment, the artist's item associated with the highest bid amount from a group of artists' items that match the association criteria places with the customer 102.

The customer or consumer 102 interfaces with a reseller 104 through the communications medium 110, which is indicated by path 114, to acquire, request, or purchase a product. In an embodiment, the reseller 104 is a music reseller 104, and the product is a product that can be delivered as digital content, such as downloadable music, video, and the like, or any physical product.

The music reseller 104 interfaces with the placement service 106 through the communications medium 110, which is indicated by path 116, and sends the placement service 106 information associated with the customer's requested product. In an embodiment, the music reseller 104 also sends the placement service 106 information associated with the customer 102.

The placement service 106 determines which of the artists' items are associated with the customer's purchase. In an embodiment, the placement service 106 interfaces with the customer 102 through the communications medium 110, which is indicated by path 118, and delivers the customer's selection or purchase along with at least one of the artists' items, such as a downloadable song, that matches association criteria associated with the customer's requested product. In another embodiment, the placement service 106 and delivers at least one of the artists' items to the customer 102 and the music reseller 104 delivers the customer's selection to the customer 102. In another embodiment, the placement service 106 delivers the artists' items to the music reseller 104 and the music reseller 104 delivers the artists' items to the customer 102.

Focusing now on the communication medium 110 as shown in FIG. 1, in one embodiment, the communications medium 110 is the Internet, which is a global network of computers. In other embodiments, the communications medium 110 can be any communication system including by way of example, dedicated communication lines, telephone networks, wireless data transmission systems, two-way cable systems, customized computer networks, interactive television networks, and the like.

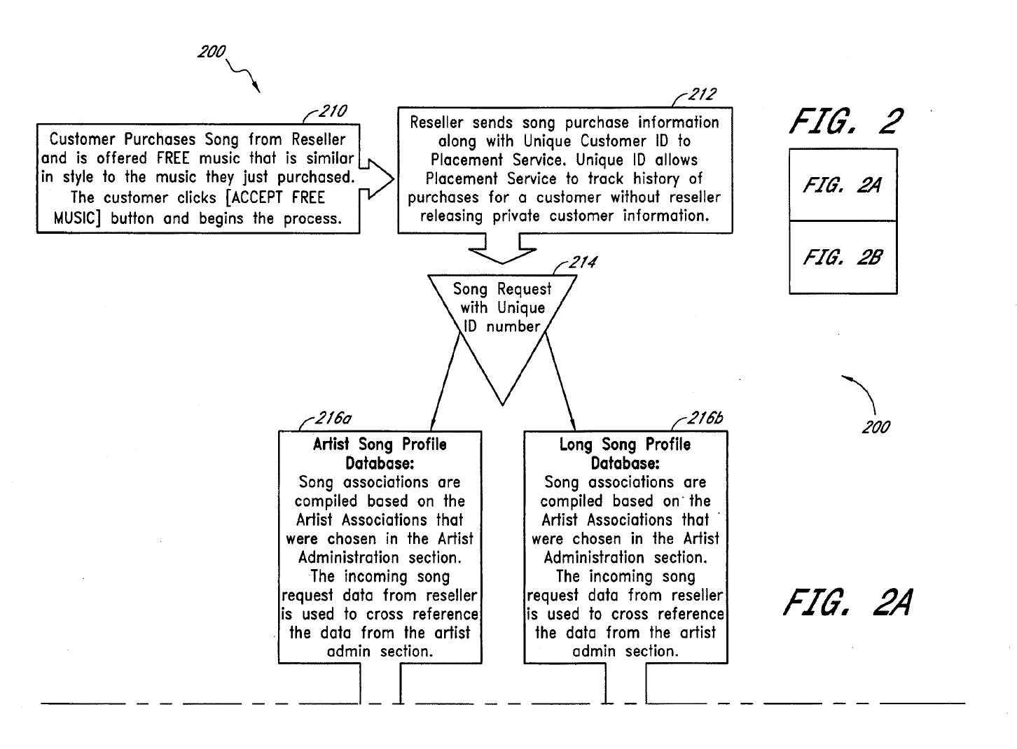

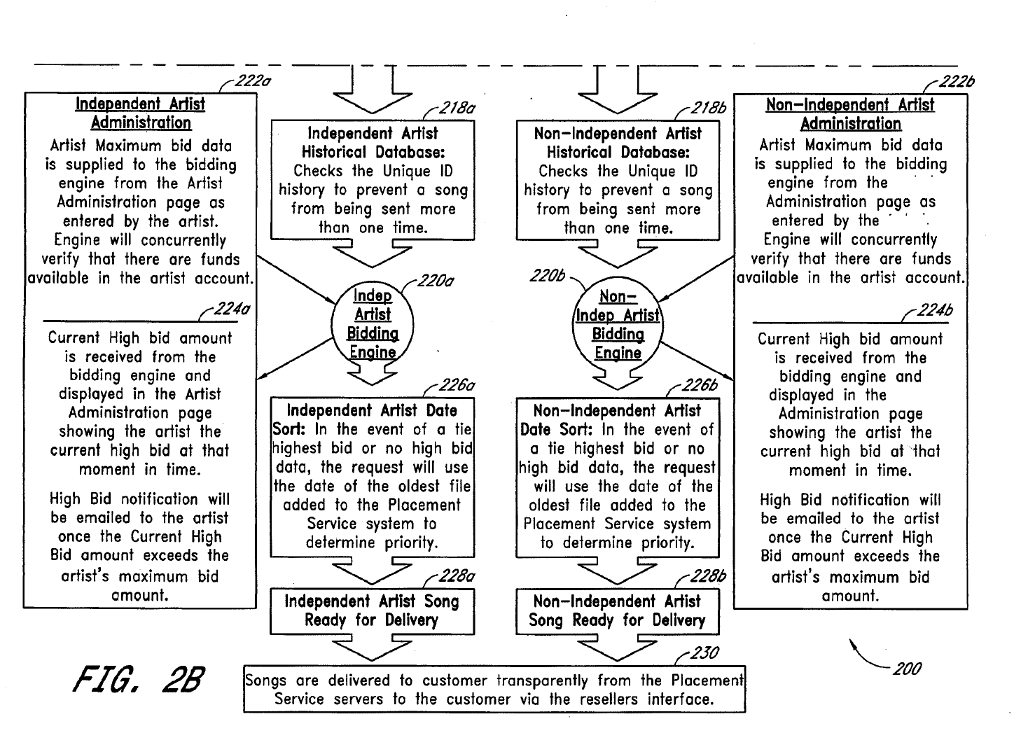

FIGS. 2, 2A, 2B are a flow chart showing a music placement process 200, according to another embodiment of the invention. In block 210, the customer 102 purchases a product, such as a downloadable song, from the music reseller 104. The customer 102 receives an offer for additional music that is similar in style to the purchased music. In an embodiment, the music reseller 104 offers the customer 102 the additional music. In another embodiment, the placement service 106 offers the customer 102 the additional music. In an embodiment, the additional music is offered at no cost to the customer 102.

In block 212, when the customer 102 accepts the offer, the reseller 104 sends selected song information about the customer's song selection and a unique customer identification associated with the customer 102 to the placement service 106. Examples of selected song information are, but not limited to the song title, the recording artist, the customer's name, the customer's delivery address, such as a street and city address or an email address, the customer's postal code, purchase date and time, and the like. In an embodiment, the unique customer identification permits the placement service 106 to track the customer's purchases without the reseller 104 releasing private customer information. In an embodiment, the customer's postal code allows the placement service 106 to track demographic sales data.

In block 214, the placement service 106 receives the selected song information and the unique customer identification. The placement service 106 cross-references the selected song information with the associations from the artists 108 to determine which of the artists' items have at least one matching association with the customer's purchased music. In an embodiment, the placement service 106 determines the matching songs from artists 108 where the artists 108 are independent music artists, as shown in blocks 216a-228a, separately from determining matching songs from artists 108 where the artists 108 are non-independent artists 108, as shown in blocks 216b-228b.

Following the independent musician path, in block 216a, the song placement service 106 compiles a database of song associations from the song associations provided by the independent artists 108. Using the selected song information and the associations database, the song placement service 106 then determines which artists' songs are similar to the purchased song.

For example, one independent artist 108 can specify that his song “Ventura Highway” is similar in style to a song by a mainstream artist titled “Summer Breeze”. When the selected song information from the reseller 104 indicates that the customer 102 purchased “Summer Breeze”, the song placement service 106 cross-references the title “Summer Breeze” with the song associations stored in the independent artist song association database and determines that the song “Ventura Highway” is associated with “Summer Breeze”.

In block 218a, the placement service 106 checks a historical transaction database, which stores the customers' unique identifications along with the artists' songs previously sent to the customer 102, to identify songs, which were previously placed with the customer 102. This can be used to prevent a song from being placed more than one time with the same customer 102. Continuing with the above example, the placement service 106 determines if the song “Ventura Highway” was previously placed with this customer 102. In an embodiment, the placement service 106 does not place the same independent artist song more than one time with the same customer 102.

The artist bidding engine 220a accesses an independent artist maximum bid database and an independent artist account database to determine whether there are sufficient funds in the account to cover the amount of the bid in block 222a.

In block 224a, the artist bidding engine 220a further retrieves the independent artist 108 having the highest bid amount and sufficient funds in his account from the group of independent artists 108 found in block 216a. That is, the placement service 106 determines which independent artist 108 has the highest bid from the group of independent artists 108 having songs which are similar to the music the customer 102 purchased. In an embodiment, the placement service 106 notifies the remaining independent artists 108 of the current high bid.

In the event that more than one independent artist 108 has bid the highest bid amount, the placement service 106 determines which independent artist 108 applied to the placement service first in block 226a. The song associated with the independent artist 108 having the highest bid and the earliest enrollment date is selected for placement with the customer 102.

In block 228a, the placement service 106 determines at least one song from the independent artists 108 enrolled in the placement system meets the criteria for placement with the customer 102. Continuing the above example, the independent artist having the song “Ventura Highway” has bid the highest bid amount of all of the independent artists 108 which have a song that is associated with the purchased song “Summer Breeze”. Further, the independent artist 108 with the song “Ventura Highway” has sufficient funds in his account to cover the bid.

Blocks 216b-228b are similar to blocks 216a-228a, but describe the process of selecting a song for placement from non-independent artists 108, such as recording companies, which are enrolled in the placement service 106. Following the non-independent musician path, in block 216b, the song placement service 106 compiles a database of song associations from the song associations provided by the non-independent artists 108. Using the selected song information, the song placement service 106 then determines which non-independent artists' songs match the song criteria associated with the customer's selected song.

For example, one non-independent artist 108 can specify that the song “Shower The People” is similar in style to a song by a mainstream artist titled “Summer Breeze”. When the selected song information from the reseller 104 indicates that the customer 102 purchased “Summer Breeze”, the song placement service 106 cross-references the title “Summer Breeze” with the song associations stored in the non-independent artist song association database and determines that the song “Shower The People” is associated with “Summer Breeze”.

In block 218b, the placement service 106 checks the historical transaction database, which stores the customers' unique identifications along with the non-independent artists' songs previously sent to the specific customer 102, to identify songs that have been previously placed with the customer. In an embodiment, the placement service 106 does not place the same non-independent artist song more than once with the same customer 102. Continuing with the above example, the placement service 106 determines that the non-independent artist song “Shower The People” was not previously placed with this customer 102.

The non-independent artist bidding engine 220b accesses the artist maximum bid database and the artist account database to determine whether there are sufficient funds in the account to cover the amount of the maximum bid in block 222b.

In block 224b, the non-independent artist bidding engine 220a further retrieves the non-independent artist 108 having the highest bid amount and sufficient funds in the account from the group of non-independent artists 108 found in block 216b. That is, the placement service 106 determines which non-independent artist 108 has the highest bid from the group of non-independent artists 108 having songs which are similar to the music the customer 102 purchased. In an embodiment, the placement service 106 notifies the remaining non-independent artists 108 of the current high bid.

In the event that more than one non-independent artist 108 has bid the highest bid amount, the placement service 106 determines which non-independent artist 108 applied to the placement service 106 first in block 226b. The song associated with the non-independent artist 108 having the highest bid and the earliest enrollment date is selected for placement with the customer 102.

In block 228b, the placement service 106 determines at least one song from the non-independent artists 108 enrolled in the placement system meets the criteria for placement with the customer 102. Continuing the above example, the non-independent artist having the song “Shower The People” has bid the highest bid amount of all of the non-independent artists 108, which have a song that is associated with the purchased song “Summer Breeze”. Further, the non-independent artist 108 with the song “Shower The People” has sufficient funds in the account to cover the bid.

The account can be a tally of points or a counting mechanism that can accept different accounting mechanisms, such as payments, credits, or debits. The account can be a point holding location where points are credited or debited to the account for placement, purchase, association, or the like.

While the above example illustrated in FIGS. 2, 2A, 2B uses bids as one way of determining the amount that is paid for placement of the placed music, other way of determining payments can be used. Examples of other payment methods include, but are not limited to, no charge for placement of the product to either the artist 108 or the customer 102, a fee, a flat fee, auctions, and the like.

While the above example illustrated in FIGS. 2, 2A, 2B the cost of placing a secondary product, such as the artist's song, with a primary product, such as the customer's selected music, is paid for by the artist 108. In other embodiments, the cost or placement fee is paid for by the customer 102. In yet another embodiment, the cost or placement fee is paid for by advertisers or other third parties, such as distributors, and the like.

In block 230, in an embodiment, the placement service 106 delivers at least one song from the independent artist 108 meeting the placement criteria, at least one song from the non-independent artist 108 meeting the placement criteria, and the purchased or requested song to the customer 102. In another embodiment, the placement service delivers 106 at least one song from the independent artist 108 and at least one song from the non-independent artist 108. In an embodiment, the placement service 106 delivers the songs transparently to the customer 102 via the reseller's customer interface. In another embodiment, a third party delivers the placed songs and the purchased song to the customer 102. In yet another embodiment, a third party delivers the placed songs to the customer 102.

In the above example, the placement service 106 sends the customer 102 the independent artist song “Ventura Highway”, the non-independent artist song “Shower The People”. Having two placement selection paths, one for independent music artists (blocks 216a-228a) and one for non-independent music artists (blocks 216b-228b), permits the independent musicians from being over bid by well-funded companies and provides a mechanism for the independent musicians to promote their music to customers that are already pre-selected to prefer their style of music.

In another embodiment, the placement service 106 delivers an offer or a partial product associated with the placed product and not the actual placed product. For example, the placement service 106 could offer the customer 102 a discount for purchase of a product that has similar characteristics with the customer's selected product, or a teaser, such as a movie trailer or a chapter from a book as an enticement to purchase the product having similar characteristics with the customer's selected product.

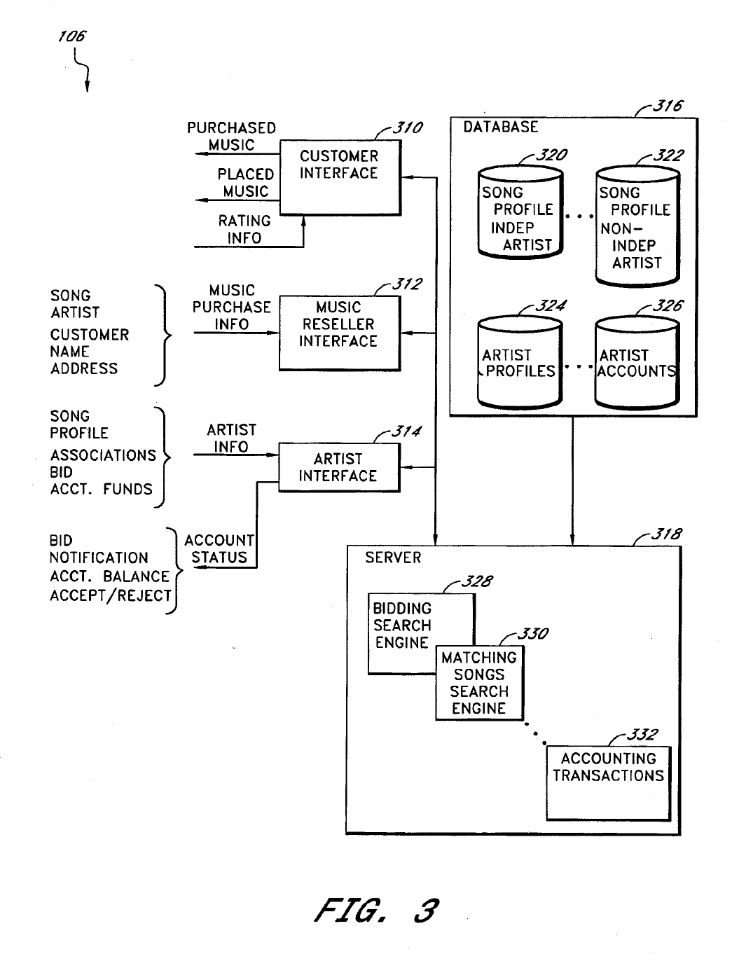

FIG. 3 is a block diagram of an exemplary music placement service 106. The music placement service 106 communicates with the customer 102 through a customer interface 310. In an embodiment, the placement service 106 sends the artist placed music to the customer 102 and receives rating information regarding the artist placed music from the customer 102 via the customer interface 310. In an embodiment, the customer 102 downloads the artist placed music from the placement service 106. In another embodiment, the customer 102 downloads the artist placed music from the reseller 104.

The placement service 106 communicates with the reseller 104 through the reseller interface 312. In an embodiment, the placement service 106 receives the song purchase information comprising the title of the song, the artist associated with the song, the unique customer identifier, the customer delivery information, and the like from the reseller 104 via the reseller interface 312. In an embodiment, the placement service 106 communicates with the customer 102 through the reseller interface 312.

Further, the placement service 106 communicates with the artist 108 through the artist interface 314. In an embodiment, the placement service 106 receives songs and/or song identifiers, song associations, bids, account information, funds for the artist accounts, artist profiles, artist biographies, and the like from the artists 108 and the placement service 106 sends bid notifications, account balances, accept/reject notifications, such as, for example, an email to the artist stating that the artist song does/does not meet the artistic or technical standards of the placement service 106, and the like to the artist 108 via the artist interface 314.

The placement service 106 further comprises one or more server systems 318 communicating with one of more database collections 316 to determine whether to place the artist's song with the customer 102. In an embodiment, the customer 102 downloads the artist placed music from the server 318.

The server system 318 comprises one or more computers. The computers comprise, by way of example, processors, program logic, or other substrate configurations representing data and instructions, which operate as described herein. In other embodiments, the processors can comprise controller circuitry, processor circuitry, processors, general-purpose single-chip or multi-chip microprocessors, digital signal processors, embedded microprocessors, microcontrollers and the like.

The server system 318 comprises bidding code 328, matching song code 330, and account transaction code 332. The server code 328, 330, 332 includes one or more software processes or program logic designed to execute on the server system 318. In one embodiment, server code 328, 330, 332 may advantageously be implemented as one or more modules. The modules may advantageously be configured to execute on one or more processors. The modules may advantageously include software or hardware components such as software object-oriented software components, class components and task components, processes methods, functions, attributes, procedures, subroutines, segments of program code, drivers, firmware, microcode, circuitry, data, databases, data structures, tables, arrays, and variables.

The database collection 316 can comprise one or more logical, and/or physical data storage systems for storing data used by the server 318. In an embodiment, the database 316 comprises an independent artist song profile database 320 for storing independent artists songs, song associations for the independent artist songs, and the like, a non-independent artist song profile database 322 for storing non-independent artist songs, song associations for the non-independent artist songs, and the like, an artist profile database 324 for storing profiles and biographies of the artists 108, and an artist account database 326 for storing account balances, bid information associated with the artist songs, and the like.

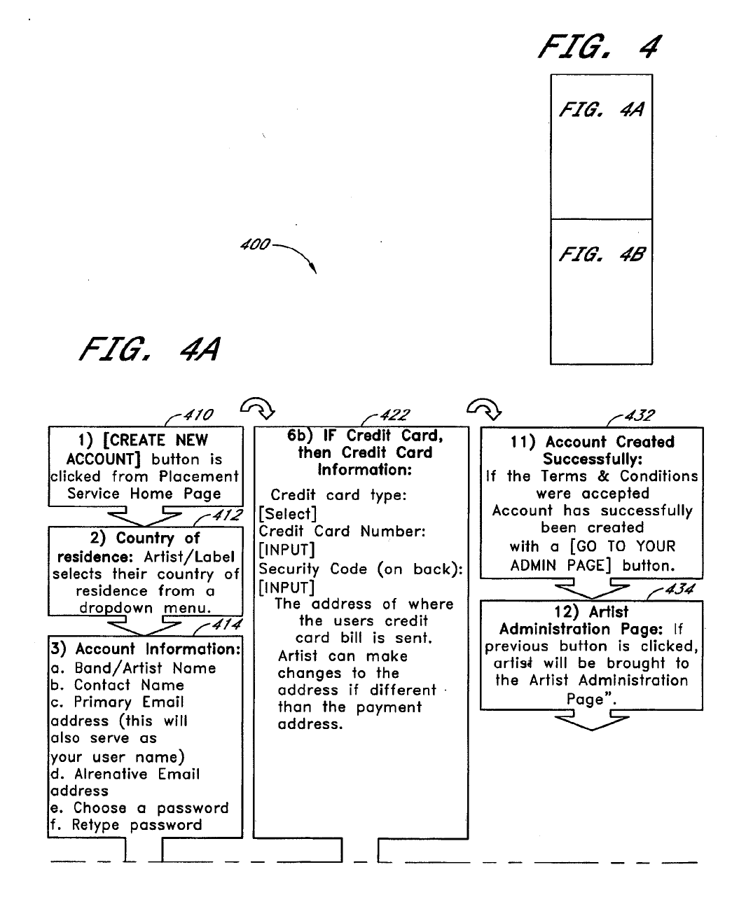

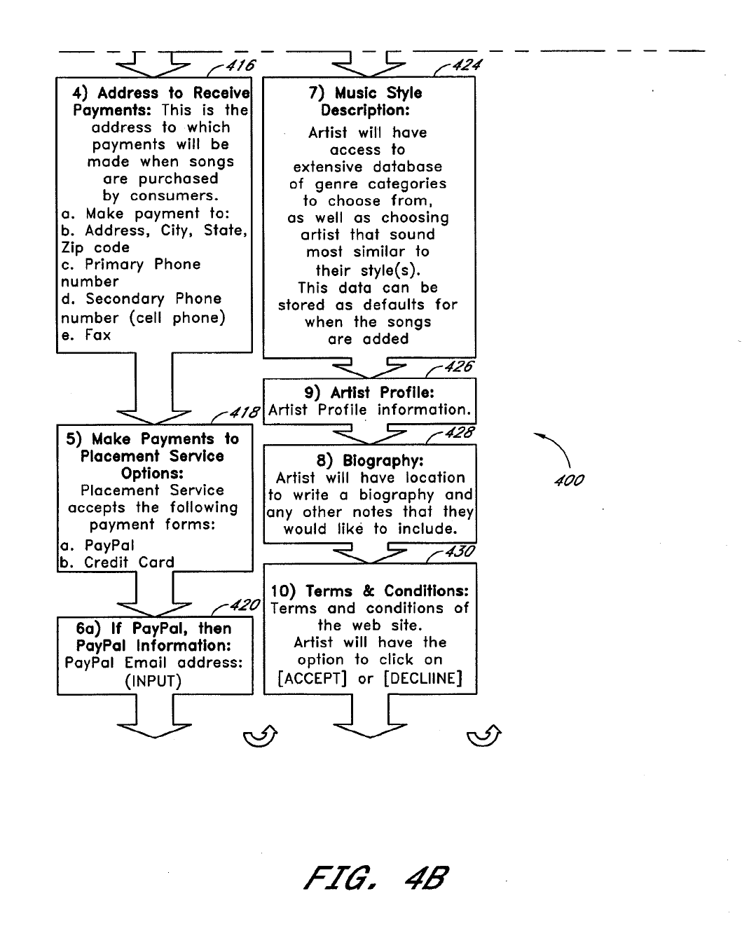

FIGS. 4, 4A, 4B illustrate an artist enrollment process 400, according to an embodiment of the invention. The artist 108 creates a new account via the artist interface 314 in block 410. The artist 108 supplies his country of residence in block 412 and account information in block 414. In an embodiment, the account information comprises band/artist name, contact name, primary email address, alternate email address, a password, and the like.

In block 416, the artist 108 supplies address information used to receive payments. In an embodiment, the customer 102 can purchase the artists songs through either the music reseller 104 or the placement service 106. Typically, this would occur after the customer 102 is exposed to the artists work through the placed song. The customer 102 can return to the music reseller 104 or the placement service 106 to purchase additional music by the artist 108. This results in the artist 108 being paid for the additional music purchased by the customer 102. This takes place with a pre-arranged profit sharing arrangement with the artist 108 that specifies the amount the artist 108 is to receive if a customer purchases music by that artist 108.

In an embodiment, the address information comprises an address including city, state, zip code, and the like, and phone numbers, such as at least one of a primary phone number, a secondary phone number, a cell phone number, a facsimile phone number, and the like.

In block 418, the artist 102 determines which payment forms to use when making payments to the placement service 106. In an embodiment, the payment forms comprise PayPal, credit cards, check, money order, wire transfer, and the like. If the artist 102 chooses to make payments using PayPal, then the artist enters a PayPal email address in block 420. If the artist 102 chooses to make payment using a credit card, then the artist 102 enters credit card information, such as credit card type, number, security code expiration date, billing address, and the like in block 422.

In block 424, the artist 102 enters a description of his music style. In an embodiment, the artist 102 enters a genre category. Examples of genre categories are avant-garde, ballet, ballad, blues, band music, Cajun, Celtic, country, folk, gospel, and the like. In another embodiment, the artist 102 enters a mainstream artist, album, or song that is most similar to his style. In an embodiment, the artist's musical style information is stored in the database 316.

In block 426, the artist 102 enters an artist profile. In block 428, the artist 102 enters an artist bibliography. In an embodiment, the artist's profile and the artist's bibliography are stored in the artist profile database 324.

In block 430, the artist 102 receives terms and conditions. In order to continue with the enrollment process 400, the artist 108 accepts the terms and conditions.

In block 432, when the artist 102 accepts the terms and conditions, the artist 102 receives an indication that the placement service 106 created the artist account. In an embodiment, the account information is stored in the account database 326.

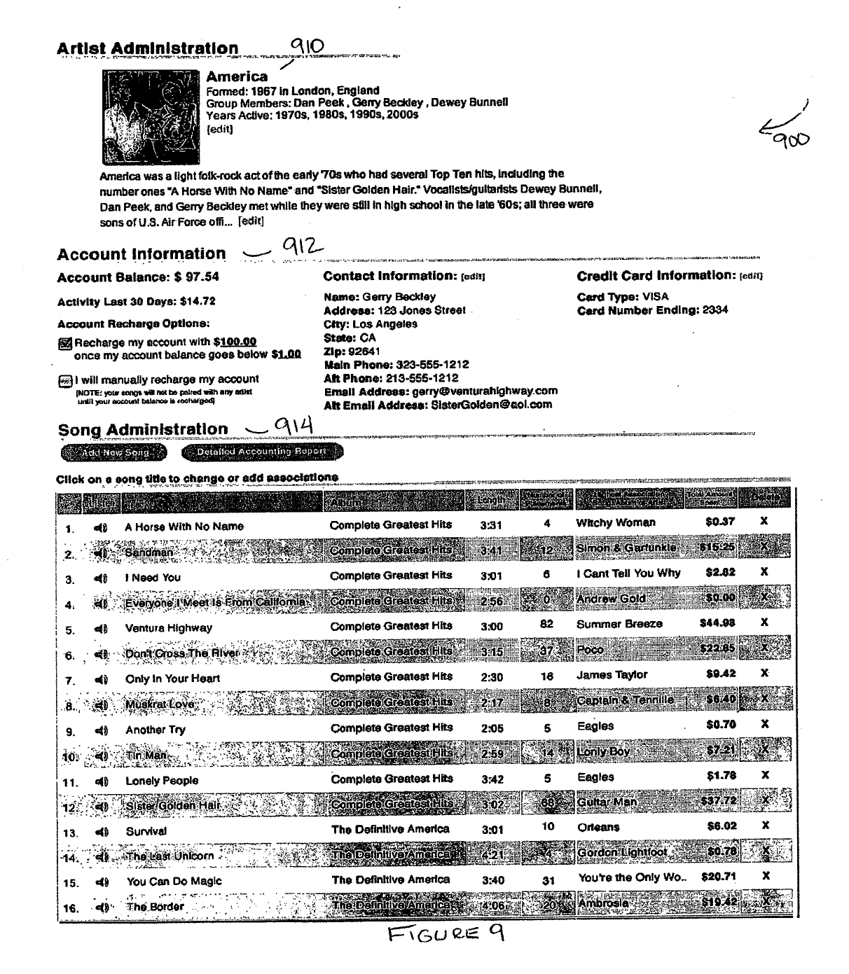

In block 434, the artist 102 can access the Artist Administration page, which provides the artist 102 with a summary of their account and song administration information. An exemplary screen shot of the Artist Administration page, illustrated in FIG. 9A, is discussed further below.

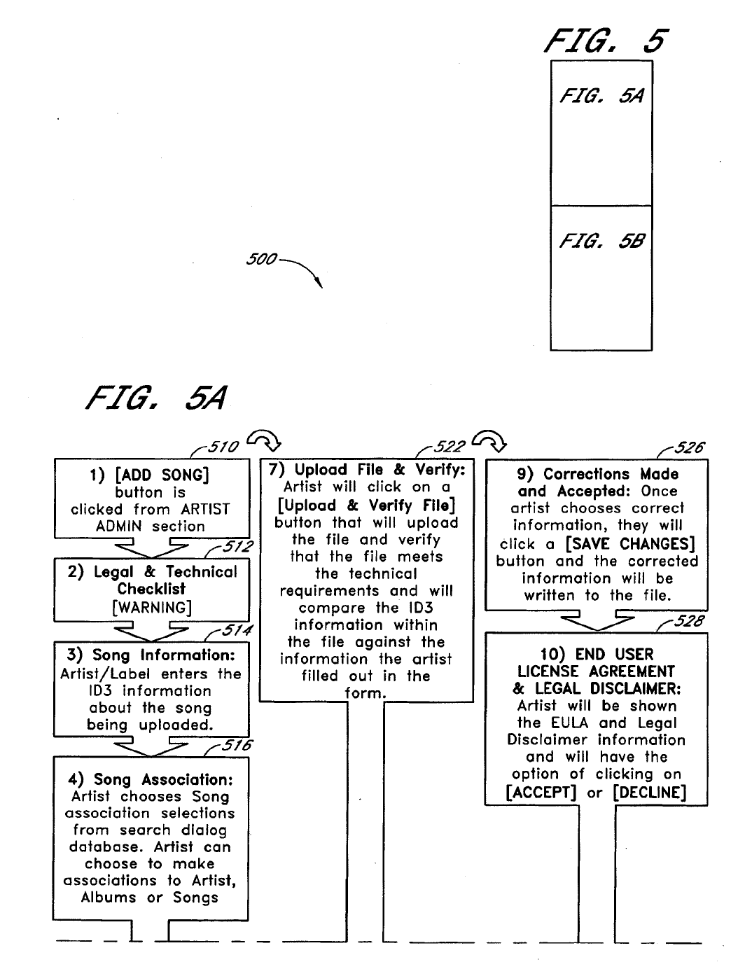

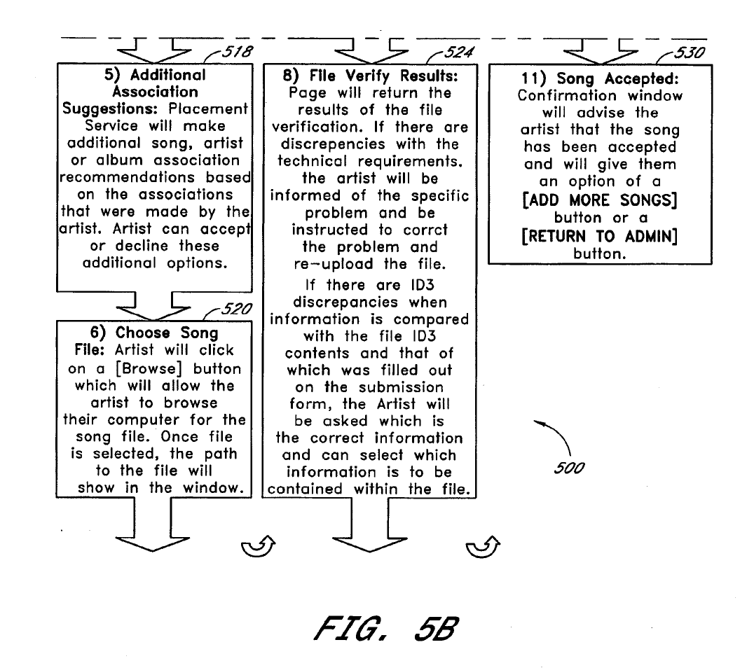

After completing the artist enrollment process 400, the artist 108 enters songs or song identifiers and song associations in a song enrollment process 500. Song identifiers are, for example, at least one of a song title, a record locator, a song, or the like. FIGS. 5, 5A, 5B illustrate the song enrollment process 500, according to an embodiment of the invention.

In block 510, the artist 108 enters the song enrollment process 500 from the Artist Administration page (FIG. 9A) by selecting ADD NEW SONG, according to one embodiment of the invention.

In block 512, the artist 108 receives a legal warning and a list of the technical requirements used to upload the artist's song to the placement service 106.

In block 514, the artist 108 enters song information. In an embodiment, the song information comprises the song title, the artist name, the album title, the year the song was recorded, comments, CD track, genre, and the like. In another embodiment, the song information comprises an ID3 tag.

In block 516, the artist 108 enters song associations that associate the artist's song with other music. In an embodiment, the artist 108 can make associations between his song and a specific artist, a specific album, a specific song, and the like. In another embodiment, the artist 108 can make associations between his song and a musical genre, a mood, a theme, a country, an instrument, and the like. In the example discussed above, the artist 108 associated his song “Ventura Highway” with the song “Summer Breeze”.

In block 518, the placement service 106 determines additional song, artist, and album associations for the artist's song, based on the associations made by the artist 108. The artist 108 can accept or decline the additional associations.

In block 520, the artist chooses his song file and in block 522, the artist 108 uploads his song to the placement service 106. In an embodiment, the placement service 106 verifies that the song and the upload meet technical requirements. In another embodiment, the placement service 106 compares the ID3 tag information with the song information supplied by the artist 108.

In block 524, if the artist's song file did not upload correctly, the placement service 106 informs the artist 102 of any technical discrepancies, instructs the artist 108 to re-upload the file when the problems are corrected. Further, if the ID3 tag information from the artist's song file does not match the song information supplied by the artist 108, the placement service 106 instructs the artist 108 to correct any discrepancies.

The artist 108 makes corrections to the song information in block 526.

In block 528, the artist 108 accepts or declines the end user license agreement and legal disclaimer. When the artist 108 accepts the end user license agreement and legal disclaimer, the artist 108 receives notification that his song is accepted by the placement service 106 in block 530. In another embodiment, the placement service 106 reviews the song and song associations to determine that the song meets standards set forth by the placement service 106 before accepting the artist's song.

The Song Association page contains a summary of the song information and song associations. An exemplary screen shot of the Song Association page, illustrated in FIG. 9B, is discussed further below.

The artist 108 can add additional songs by returning to the beginning of the song enrollment process 500.

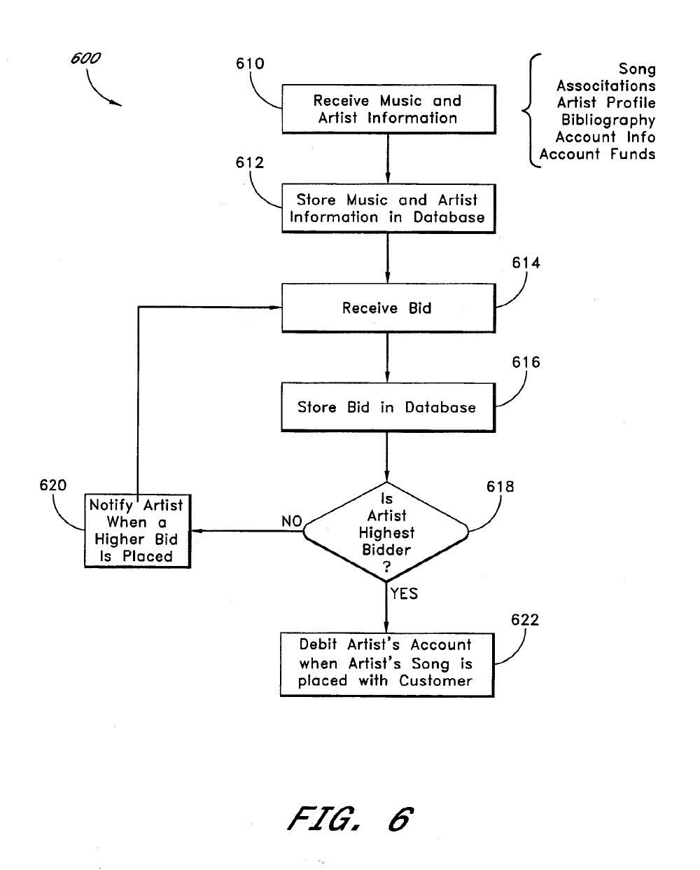

FIG. 6 illustrates a bidding for placement process 600, according to an embodiment of the invention. In order to increase the likelihood of the artist's items being placed with the customer selected products, the artist 108 can bid against other artists 108 for placement. The artist 108 with the highest bid having a song associated with the music purchased by the customer 102 wins placement of the song with the customer 102. Each time the artist 108 wins the chance to be paired with another artist, the placement service debits the bid amount from the artist's account. A bidding artist 108 can be outbid by another artist 108 when a higher bid is placed. The bidding artist 108 is notified when a higher bid is placed, and the bidding artist 108 has the opportunity to submit a higher bid.

Referring to FIG. 6, in block 610, the music placement service 106 receives the artist's music and artist information. The music placement service 106 stores the artist's music and artist information in the database 316 in block 612. In an embodiment, the artist information comprises at least one of a song, a song identifier, song associations, an artist profile, an artist biography, account information, and account funds.

In block 614, the placement service 106 receives a bid from the artist 108. The bid comprises the amount of money the artist 108 is willing pay to have his song placed with or delivered to the customer 102 who selects music that is associated with his song. In another embodiment, the bid is the amount of money an advertiser is willing to pay to have the artist's song delivered to the customer 102. In block 616, the placement service 106 stores the bid in the database 316.

In block 618, the placement service 106 determines whether the artist 108 has the highest bid associated with a specific song, artist, or album.

In block 620, when the artist 108 does not have the highest bid, the placement service 106 notifies the artist 108 that a higher bid has been placed. The artist has the option of increasing his bid, which is received in block 614.

In block 622, when the artist 108 has the highest bid, the placement service 106 debits the artist's account by the amount of the bid when the artist's song is placed with the customer 102.

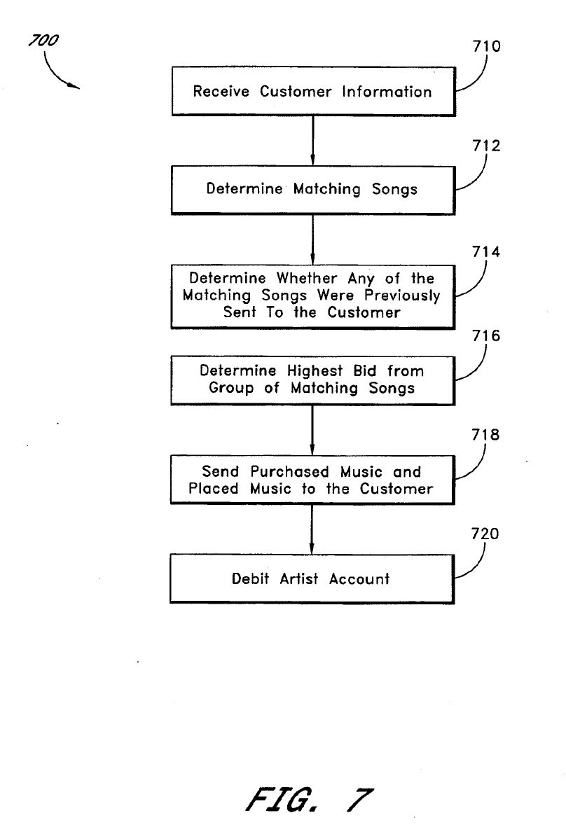

FIG. 7 illustrates a music placement process 700, according to another embodiment of the invention. In block 710, the placement service 106 receives customer information from the music reseller 104. In an embodiment, the customer information comprises the music the customer 102 selected, the unique customer identification, and the like. In an embodiment, the customer information further comprises the customer's delivery address, such as a post office box, a street address, or a web address.

In block 712, the placement service 106 determines which of the artist's songs stored in the database 316 are associated with the customer's music.

In block 714, the placement service 106 determines whether any of the matching songs were previously sent to the customer 102 associated with the unique customer identification. In an embodiment, artist's songs that were previously sent to the customer 102 are not sent to the same customer 102 to prevent customers 102 from receiving duplicate placed songs.

In block 716, the placement service 106 reviews the bids associated with the matching songs and determines which matching song has the highest bid. Further, the music placement service 106 verifies that the account associated with the matching song having the highest bid has sufficient funds.

In block 718, the placement service 106 places the matching song with the customer 102. In an embodiment, the placement service 106 delivers the matching song with the highest bid to the customer 102. In another embodiment, the placement service 106 delivers at least one matching song having the highest bid from an independent music artist and at least one matching song having the highest bid from a non-independent music artist to the customer 102. In another embodiment, the music placement service 106 further delivers the customer's requested or purchased music to the customer 102. In another embodiment, the customer 102 downloads the matching song or songs from the placement service 106.

In another embodiment the music reseller 104 delivers the matching song with the highest bid to the customer 102. In another embodiment, the music reseller 104 delivers at least one matching song having the highest bid from an independent music artist and at least one matching song having the highest bid from a non-independent music artist to the customer 102. In another embodiment, the music reseller 104 further delivers the customer's requested or purchased music to the customer 102. In another embodiment, the customer 102 downloads the matching song or songs from the music reseller 104.

In block 720, the placement service 106 debits the account associated with the placed song.

In another embodiment, the placement service 106 selects at least one song to be placed with the customer's music. The songs may or may not be associated with the customer's music. The placement service 106 determines if any of the songs were previously sent to the customer 102 to prevent duplicate songs from being sent to the same customer 102. The placement service 106 selects the song associated with the highest bid to be placed with the customer 102.

In an embodiment, the customer 102 can distribute or refer the placed song to friends. In an embodiment, the customers 102 send friends a link to the placed song. When the placed song is downloaded by the customer's referral, the artist's account is debited.

In an embodiment, the customer 102 sends the placement service 106 reviews or ratings of the music placed with the customer 102. In an embodiment, the placement service 106 stores the customer reviews in the database 316 and uses the customer reviews in the artist song selection process. In an embodiment, the customer 102 sends the placement service 106 reviews through the customer interface 310. In another embodiment, customer 102 sends the placement service 106 reviews via the reseller's user interface.

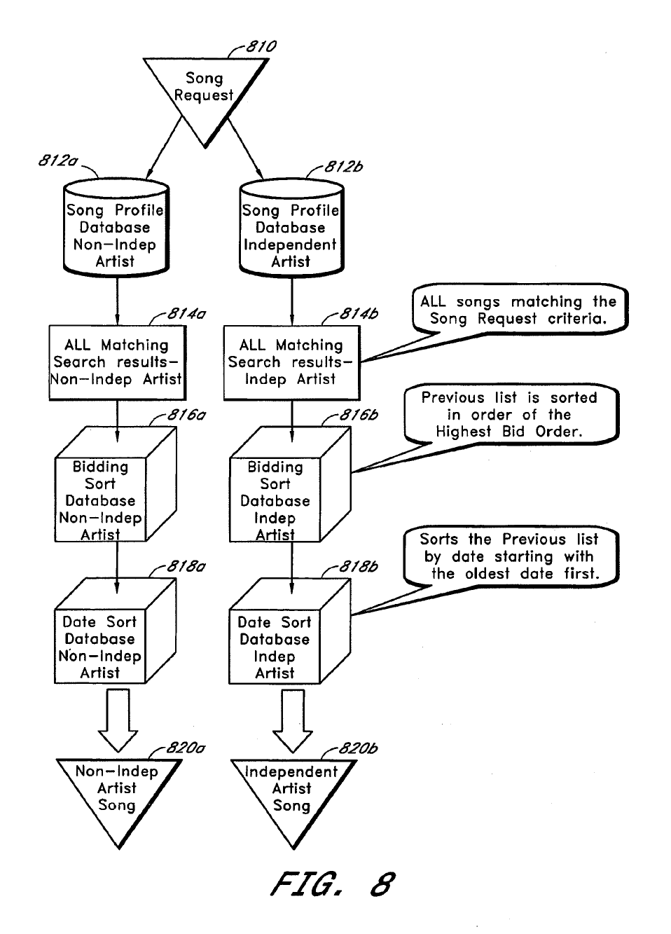

FIG. 8 illustrates a song selection process 800 having a non-independent artist path (blocks 812a-820a) and an independent artist path (blocks 812b-820b), according to an embodiment of the invention. In block 810, the server 318 receives a request to find songs that are associated with the customer's selected song.

Following the non-independent artist path, in block 812a, the server 318 accesses the song profile database 322 containing song associations for songs enrolled by non-independent music artists 108, such as, for example, recording companies.

In block 814a, the server 318 uses the search criteria to find the songs associated with the customer's selected song and generates a list of the non-independent artist matching songs. In an embodiment, the search criteria comprises at least one of associated song titles, associated artists, associated albums, associated moods, associated musical genres, associated instrumentation, associated musical themes, associated countries, and the like.

In block 816a, the server 318 sorts the list of matching songs found in block 814a by the bid associated with each song. In an embodiment, the server 318 sorts the list of matching songs in order of highest bid to lowest bid.

In block 818a, the server 318 sorts each sub-group of matching songs having the same bid amount by the date that the artist 108 enrolled the song in the placement service 106. In an embodiment, the server 318 sorts the sub-groups in order of oldest date to most recent date.

In block 820a, the server 318 selects the non-independent artist song having the highest bid from the list of matching songs. In the event that more than one matching song has the highest bid, the server selects the non-independent artist song having the highest bid and the oldest enrollment date. The placement service 106 sends the selected song to the customer 102 and debits the artist's account by the bid amount.

In an embodiment, the server 318 also processes the independent artist path to select a song from an independent music artist to place with the customer 102.

Following the independent artist path, in block 812b, the server 318 accesses the song profile database 320 containing song associations for songs enrolled by independent music artists 108.

In block 814b, the server 318 uses the search criteria to find the songs associated with the requested song and generates a list of the matching independent artist songs. In an embodiment, the search criteria comprises at least one of associated song titles, associated artists, associated albums, associated moods, associated musical genres, associated instrumentation, associated musical themes, associated countries, and the like.

In block 816b, the server 318 sorts the list of matching songs found in block 814b by the bid associated with each song. In an embodiment, the server 318 sorts the list of matching song in order of highest bid to lowest bid.

In block 818b, the server 318 sorts each sub-group of matching songs having the same bid amount by the date that the independent artist 108 enrolled the song in the placement service 106. In an embodiment, the server 318 sorts the sub-groups in order of oldest date to most recent date.

In block 820b, the server 318 selects the independent artist song having the highest bid from the list of matching songs. In the event that more than one matching song has the highest bid, the server 318 selects the independent artist song having the highest bid and the oldest enrollment date. The placement service 106 sends the selected song to the customer 102 and debits the artist's account by the bid amount.

FIG. 9 is an exemplary screen shot illustrating an Artist Administration page 900. As shown in FIG. 9, the Artist Administration page comprises a profile 910, an account administration section 912, and a song administration section 914.

The artist profile 910 comprises a brief description of the artist. In an embodiment, the artist 108 provides the artist profile 910.

The account information section 912 comprises the current account balance, account recharge options, artist contact information, and artist credit card information.

The song administration section 914 comprises a list of the songs that the artist 108 has enrolled with the placement service 106. The list comprises the song title, the name of the album that the song is from, the play time of the song, the number of times the song has been downloaded or placed with the customer 102, and the amount of money that the artist 108 has spent for placing the song.

In an embodiment, the artist 108 can change, add, or delete associations for a particular song from the song administration section 914. In an embodiment, each artist song enrolled in the placement service 106 can be associated with more than one song, album, artist, or the like. The song administration section 914 further comprises the association that created the most downloads.

For example, the artist's song “Ventura Highway” from the album “Complete Greatest Hits” has been placed with customers 102 eighty-two (82) times. Of all the associations the artist provided for “Ventura Highway”, the association to the song “Summer Breeze” provided the most associations.

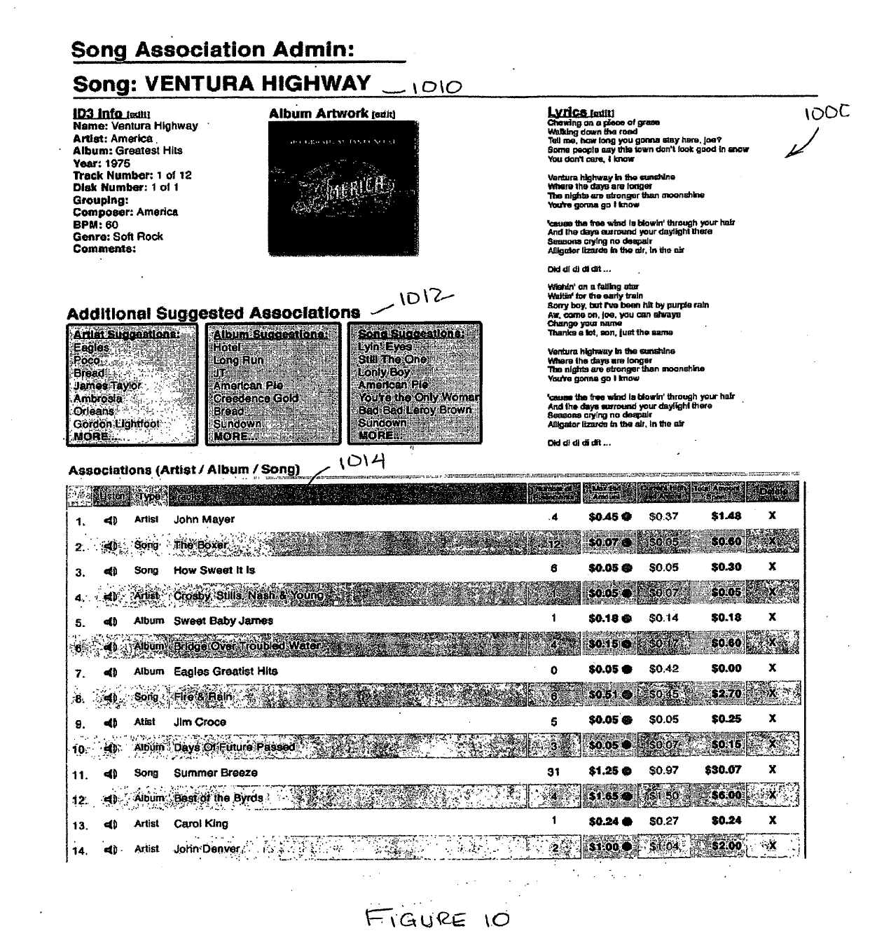

Referring to FIG. 10, which is described in more detail below, the association of “Summer Breeze” provided 31 placements. Further, the artist 108 spent $0.97 for each song placement that was associated with the song “Summer Breeze”.

FIG. 10 is an exemplary screen shot illustrating a Song Association Administration page 1000. The Song Association Administration page 1000 comprises artist song information 1010, pairing suggestions 1012, and a list of the music 1014 with which the artist's song is associated. In an embodiment, the associated music 1014 comprises artists, album, and songs.

The artist song information 1010 comprises the song title, the tag information, such as the ID3 data, the song lyrics, and information concerning the album containing the artist's song, such as, for example, a picture of the album cover.

The pairing suggestions 1012 comprise suggested artists, suggested albums, or suggested songs that are similar to the artist's song. In an embodiment, the placement service 106 provides the pairing suggestions 1012.

The list of associated music 1014 comprises the name of the associated music, the association type, such as, for example, album, song, or artist, the number of times the artist's song has been placed with the associated music, the bid amount that the artist 108 bid to place his song with the associated music, the current high bid amount, and the total amount the artist 108 has spend placing his song with the associated music.

For example, the artist 108 has associated his song “Ventura Highway” with the artist “John Mayer”, the song “Fire & Rain”, the song “How Sweet It Is”, the album “Eagles Greatest Hits”, and the other entries on the list 1014. The artist 108 set a maximum bid amount of $0.45 to have “Ventura Highway” placed with “John Mayer” and his current high bid is $0.37. The artist's song “Ventura Highway” was placed four times with customers 102 that purchased “John Mayer” music from the music reseller 104 and the artist 108 has spent $1.48 placing his song “Ventura Highway” with customers 102 that purchased “John Mayer” music.

While certain embodiments have been described using the digital music industry and digital music content as examples, the novel methods and systems described herein are applicable to a variety of products and industries.

In another embodiment, the reseller 104 comprises an on-line video store and the product comprises digital video content. For example, the customer 102 requests or purchases a downloadable movie from a digital video reseller 104 and is offered a complementary movie that is similar to their purchased movie. The reseller 104 sends the placement service 106 customer information comprising, for example, the title of the purchased movie, movie subject, the customer's delivery address, and the like.

The placement service 106 also receives short films, movies, and/or videos from film artists 108. In addition, the film artists 108, such as independent film artists, movie studios, or the like, provide associations associating their works with other film artists, movies, and the like. Using the systems and methods described above, the placement service 106 cross-references the associations with the characteristics of the customer's requested movie to determine which video content from the film artists 108 shares similar characteristics with the customer's requested movie.

To increase the likelihood of placing their video with a similar movie, the film artists 108 can bid against one another for placement with the customer 102. Using the systems and methods described above, the placement service 106 determines which film artist 108 associated with a video that is similar to the customer's requested movie has the highest bid. The film artist 108 with the highest bid and sufficient funds in his account pays to have his video delivered to the customer 102 along with the customer's requested movie. When the film artist's video is delivered to the customer 102, the placement service 106 debits the film artist's account by the amount of the bid.

In another embodiment, the reseller 104 comprises a traditional retail store, and the product is any physical product, data object, or the like. For example, the customer 102 purchases a beverage in a grocery store 104 and is offered at least one complementary sample of a similar beverage. The grocery store 104 sends the placement service customer information, such as the product's bar code information, the customer's loyalty card information, and the like.

The placement service 106 receives samples of beverage products from other beverage manufacturers, providers or third party distributors 108. Further, the beverage providers 108 provide associations between their beverage and other products. Using the systems and methods described above, the placement service 106 cross-references the associations with the characteristics of the customer's purchased beverage to determine which beverage or other product from the provider 108 shares similar characteristics with the customer's purchased beverage.

To increase the likelihood of placing their beverage with a similar beverage, the providers 108 can pay a fee for placement with the customer 102. Using the systems and methods described above, the placement service 106 determines which provider 108 associated with a beverage that is similar to the customer's purchased beverage has the highest fee. The provider 108 with the highest fee and sufficient funds in his account pays to have his beverage presented to the customer 102. When the provider's beverage is presented to the customer 102, the placement service 106 debits the provider's account by the amount of the fee.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of music distribution comprising:
receiving at least one identifier associated with a song selected by a consumer;
determining whether the song selected by the consumer is associated with at least a second song;
issuing a message approving download of the associated second song to the consumer; and
debiting an account associated with a promoter of the second song by an amount when the second song is presented to the consumer.

2. The method of claim 1 wherein the second song is associated with an independent music artist.

3. The method of claim 2 further comprising:
determining whether the song selected by the consumer is associated with at least a third song;
issuing a second message approving download of the third song to the consumer when the song selected by the consumer is associated with the third song; and
debiting an account associated with a promoter of the third song by a second amount when the third song is presented to the consumer, wherein the third song is associated with a non-independent music artist.

4. The method of claim 1 wherein when the song is presented to the consumer comprises when the song is delivered to the consumer.
